(19) United States
(12) Patent Application Publication
(10) Pub. No.: US 2010/0269090 A1
(43) Pub. Date: Oct. 21, 2010

(54) METHOD OF MAKING IT POSSIBLE TO SIMPLIFY THE PROGRAMMING OF SOFTWARE

(75) Inventor: Pascal Le Merrer, Noyal Sur Vilaine (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/760,623

(22) Filed: Apr. 15, 2010

(30) Foreign Application Priority Data
Apr. 17, 2009 (FR) 09 52534

(51) Int. Cl. G06F 9/44

(52) U.S. Cl. 717/105

(57) ABSTRACT

A method for aiding the programming of software comprising a step of displaying a description area used to display a graphical description of said software and at least one step of displaying at least one interface element in a control area so as to propose to a user that he undertake an operation for describing said software by instructing an update of said graphical description by means of said interface element, the description operation currently proposed being dependent each time on the last description operation performed, in such a way as to prompt the user to define said software according to a predefined succession of description operations.

### CROSS-REFERENCE TO RELATED PATENT APPLICATION

This application claims the benefit of French Patent Application No. 09 52534, filed on Apr. 17, 2009, in the French Institute of Industrial Property, the entire contents of which is incorporated herein by reference.

### FIELD OF THE INVENTION

The invention relates to the field of computing and more precisely to a method for aiding the programming of software as well as to an associated device.

### BACKGROUND

Software programming is a complex task, which requires considerable learning. The majority of programming languages use a language in the form of text with syntax specific to that language. However, there exist graphical languages which make it possible to reduce programming complexity, to the detriment, however, of the power of expression of the language. Graphical languages have the advantage of eliminating or greatly reducing the learning of the syntax of the language, and avoid syntax errors. They are therefore well suited to a public new programming.

However, the user must still learn the programming logic. He must also discover all the instructions made available to him by this graphical language, together with their meaning, and know when to use each. The meaning of the instructions of a graphical language, even if they may be more explicit than those of a traditional programming language, is not always intuitive.

A requirement is therefore apparent for a system for aiding software programming, which makes it simpler and faster to create a program, in particular which reduces the learning phase required on the part of the user.

One of the aims of the invention is to remedy problems, drawbacks or inadequacies of the prior art and/or to afford improvements thereto.

### SUMMARY

The invention relates, according to a first aspect, to a method for aiding the programming of software comprising:
a step of displaying a description area used to display a graphical description of at least one action to be executed by said software subsequent to an occurrence of at least one event,
at least one step of displaying in a control area at least one interface element by mean of which a user may undertake an operation for describing said action or event causing an update of said graphical description,

the description operation currently proposed being each time dependent on the last description operation performed, in such a way as to prompt the user to define said software according to a predefined succession of description operations.

The user is guided step by step through the description of the software: he therefore merely has to undertake the description operation proposed each time so as to end up with a complete description of his software. The order proposed for the description operations being predefined, the user's task is considerably simplified.

The user is thus guided by a description method which defines the next description step: this facilitates his description work and makes learning useless. The user does not have to ask himself about the next step, and how to proceed.

According to one embodiment of the method according to the invention, if it is detected that the user has selected a graphical element in the description area, the description operation proposed is dependent on the graphical element selected. The invention allows the user, at any instant, to modify a graphical element present in the description of the software or a predetermined part of this description.

According to one embodiment of the method according to the invention said description area comprises a selectable action description area for the description of said action, wherein the proposed description operation is an addition of another action to be executed before of after said action when said action description area is selected. The user is thus prompted to perform a description operation in relation with the selected area. He is thus guided by a description method: this facilitates the description work and renders learning useless.

According to one embodiment of the method according to the invention said description area comprises a selectable event description area for the description of said event, wherein the proposed description operation is an addition of another event or of another action associated with said event when said event description area is selected. The user is thus prompted to perform a description operation in relation with the selected area. He is thus guided by a description method: this facilitates the description work and renders learning useless.

According to one embodiment of the method according to the invention, the description operation currently proposed is a description operation that has already been proposed to the user but has not been performed by the user. The user is thus warned of his omissions so as, once again, to prompt the user to define the software according to a predefined succession of description operations.

According to another embodiment, the method according to the invention furthermore comprises a step of automatically selecting from the description area a graphical element pertinent to the description operation proposed. The user is thus informed clearly regarding the part of the software which is currently described.

According to yet another embodiment of the method according to the invention, said software is able to be described on the basis of objects representing an action or an event, and the currently proposed description operation is one of the operations included in the group comprising:
addition of an object,
choice of a type of object for an object to be created,
definition of a parameter for a created object.

On account of this choice limited to an elementary description operation, the user is guided and is at no risk of performing the description of the software in an arbitrary, inappropriate order or of omitting a description operation.

According to yet another embodiment of the method according to the invention, when the currently proposed description operation consists in choosing a type of object, a list of user interface elements each associated with a type of object is displayed during the display step.

This simplifies the work of the user who has only one choice to make from the proposed list, without having to ask himself questions as regards compatibility between the object to be created and the types of objects proposed.

The various embodiments mentioned above are mutually combinable for the implementation of the invention.

The invention relates, according to a second aspect, to a device for aiding the programming of software comprising an assistant for
displaying a description area used to display a graphical description of at least one action to be executed by said software subsequent to an occurrence of at least one event,
displaying in a control area at least one interface element by mean of which a user may undertake an operation for describing said action or event causing an update of said graphical description,

the description operation currently proposed being dependent each time on the last description operation performed, in such a way as to prompt the user to define said software according to a predefined succession of description operations.

The advantages stated for the method according to the invention are directly transposable to the device according to the invention.

More generally, the device according to the invention comprises means for implementing the steps of the method according to the invention.

According to a preferred implementation, the various steps of the method according to the invention are implemented by software or computer program, this software comprising software instructions intended to be executed by a data processor of a terminal or device and being designed to control the execution of the various steps of this method.

Consequently, the invention is also aimed at a program, able to be executed by a computer or by a data processor, this program comprising instructions for controlling the execution of the steps of a method as mentioned above.

This program can use any programming language, and be in the form of source code, object code, or of code intermediate between source code and object code, such as in a partially compiled form, or in any other desirable form.

The invention is also aimed at an information medium readable by a computer or data processor, and comprising instructions of a program as mentioned above.

The information medium can be any entity or device capable of storing the program. For example, the medium can comprise a storage means, such as ROM, for example a CD ROM or a microelectronic circuit ROM, or else a magnetic recording means, for example a diskette (floppy disk) or a hard disk.

Moreover, the information medium can be a transmissible medium such as an electrical or optical signal, which can be conveyed via an electrical or optical cable, by radio or by other means. The program according to the invention can in particular be downloaded from a network of Internet type.

Alternatively, the information medium can be an integrated circuit into which the program is incorporated, the circuit being adapted for executing or for being used in the execution of the method in question.

### BRIEF DESCRIPTION OF THE DRAWINGS

Other aims, features and advantages of the invention will be apparent through the description which follows, given solely by way of nonlimiting example, and with reference to the appended drawings in which:

FIG. 1 represents in a schematic manner an example of a user interface used in the implementation of the method according to the invention;

FIG. 2 represents a flowchart of an embodiment of the method according to the invention;

FIGS. 3A to 3H represent in a schematic manner examples of modifying the user interface used in the implementation of the method according to the invention, during the various steps represented in FIG. 2.

### DETAILED DESCRIPTION

The method according to the invention is intended to be implemented by means of software executed on a user's terminal, for example a terminal of personal computer type, comprising a central processing unit, a display screen, a keyboard and a mouse, in the guise of pointing tool. Such a terminal is an example of a device according to the invention.

The device according to the invention is implemented for example in the form of a terminal or personal computer, with display means (typically a screen), processing means (typically a data processor, or any machine for executing program instructions) for executing the steps of a method according to the invention, a record medium, readable by said processing means, on which is recorded a program comprising program code instructions for executing the step of the method according to the invention.

The principles of the invention are described in the context of the creation of a software module of “widget” or “software gadget” type, that is to say of a graphical software component, intended to be displayed on a computer screen and which makes it possible to obtain services or information. A software module such as this is designed to trigger an execution of at least one action subsequent to an occurrence of at least one event.

A software module or software component corresponds to one or more computer programs, one or more subroutines of a program, or more generally to any element of a program or software able to implement a function or a set of functions.

The software module is described by means of a graphical language, comprising a set of graphical instructions, that is to say instructions represented with the aid of graphical elements (symbols, geometric shapes, arrows, etc.), optionally combined with text. These instructions serve to describe at one and the same time the object or objects involved in the execution of the software module, as well as the parameter or parameters of these objects. In this document, a graphical description stands for a description by means of a graphical language.

For description of such a software module, different objects may be used. An object is for example an event or an action.

An event defines the moment at which the associated action or actions must be executed, in relation for example to movements of a pointer showing on the display screen the movements of the pointing tool (mouse typically) or the selections performed by this user by means of this pointing tool, for example:
when the pointer hovers over a predefined graphical component;
when the pointer leaves a predefined graphical component;
when the user clicks on a predefined graphical component;
when the value of a property of a predefined graphical component changes.

With each of these moments is associated a type of event or set of possible events: for example, the type of event “when the pointer hovers over a predefined graphical component” corresponds to a set of events comprising as many events as graphical components over which it is possible to hover: a first event EA corresponding to hovering over a first graphical component A, a second event EB corresponding to hovering over a second graphical component B, etc.

An action is a processing performed in the course of the execution of the software module. Any type of processing is conceivable, for example:
display a text and/or an image,
send a message,
open a file,
copy information,
perform a calculation.

It is assumed in the context of this document, that an event may not be described in relation to another event. On the other hand, an action may be described in relation to other actions: these are nested actions. This is useful for example for defining a complex calculation function by nesting elementary calculation functions.

Most events and actions are defined by means of one or more parameters, which allow the behaviour of these events or actions to be rendered dynamic in the course of the execution of the software module.

For example:
the event “when the user clicks on a predefined graphical component” must be defined on the basis of a parameter which identifies the graphical component for which a detection has to be made;
an action of sending an SMS (Short Message Service) message must be defined on the basis of at least two parameters: the text to be sent and the telephone number of the destination.

The parameters of an event or of an action can be defined:
either by a calculation function, which generates a given value during the execution of the software module (for example the text contained in an entry field, the result of a calculation, etc.);
or by a fixed value, defined during programming: in this case this signifies that the value of the parameter will not change in the course of the execution of the software module.

The parameters have a type which defines the nature of the parameter: character string, numerical value, Boolean, date, time, email address, graphical component identifier, etc.

An action requires parameters which are:
either of a given type: for example the “destination” parameter of a send SMS action is necessarily of “telephone number” type
or of a variable type: the “text” parameter of a send SMS action may just as well contain a text, as a URL, a numerical value etc.

According to the invention, the user is guided step by step during the programming of the software module. The software for aiding programming is hereinafter dubbed “assistant”.

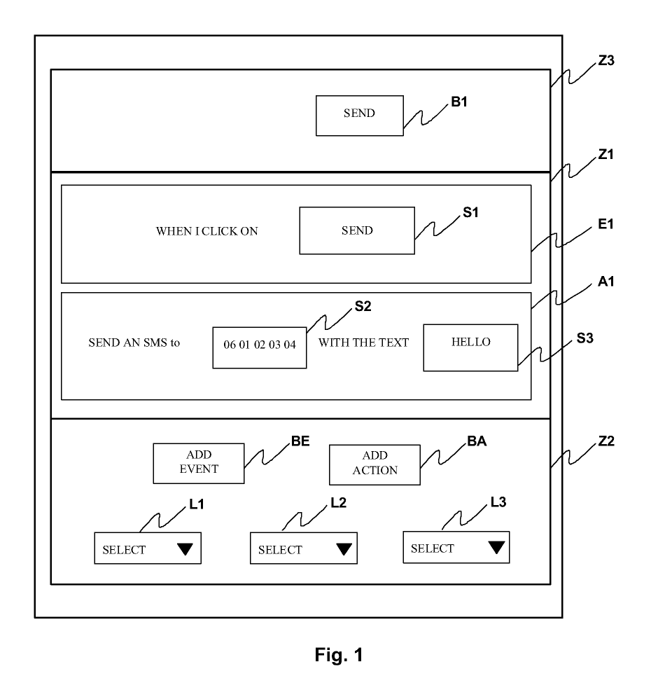

The assistant implements an appropriate user interface, an example of which is represented in FIG. 1. This user interface principally comprises three areas:
a first area Z1 for displaying the description of the software module, or only a part of this software module (for example, the description of an event or of an action), this graphical description being composed of graphical instructions; this first area is dubbed the description area Z1;
a second area Z2 for displaying interface elements that can be selected by the user to instruct an update (modification of at least one element, addition or deletion of at least one element) of the graphical description of the software module, this modification giving rise to a modification of the graphical description displayed in the description area Z1; this second area is dubbed the control area Z2;
a third area Z3 for displaying the user interface of the software module to be programmed, comprising a graphical representation of the interface elements used in this software module; this third area is dubbed the drawing area Z3.

The drawing area Z3 comprises an interface element B1 of “button” type to be clicked, representing a selectable element of the software module to be programmed, which in the example described here, is intended to be used to trigger the sending of an SMS (Short Message Service) message to a predefined recipient user.

The description area Z1 comprises an area E1 dedicated to the graphical description of an event, associated with the button B1, in this instance of an event of type “when the user clicks on a predefined graphical component”. The graphical description of this event comprises, on the one hand, a text (“when I click on”) and, on the other hand, an area S1 for entering a parameter of this event, this area S1 being intended to receive an identifier of a graphical element of the drawing area Z3, in this instance the identifier of the button B1.

The description area Z1 comprises an area A1 dedicated to the graphical description of an action, associated with the button B1, and intended to be triggered when the event described in the area E1 occurs. The graphical description of this action comprises, on the one hand, text (“send an SMS to” and “comprising the text”) and, on the other hand, an area S2 for entering a first parameter of this action, to receive a telephone number of the recipient user of the SMS, as well as an area S3 for entering a first parameter of this action to receive the text of the SMS to be sent.

The interface elements displayed in the control area Z2 are used to instruct updates of the graphical description of the software module as displayed in the description area Z1. Such an interface element is either an interface element in the form of a list for selection of a type of object, or an interface element, in the form of a “button” to be clicked or a hypertext link, for instructing the addition of an object.

The control area Z2 comprises for example:
an interface element BE, in the form of a button to be clicked, to instruct the addition of an event;
an interface element BA, in the form of a button to be clicked, to instruct the addition of an action;
an interface element L1, in the form of a list for selecting a type of event, to be used for defining an event;
an interface element L2, in the form of a list for selecting a type of action, to be used for defining an action;
an interface element L3, in the form of a list for selecting a parameter calculation function, to be used for defining a parameter of an action or event.

An interface element in the form of a list makes it possible to instruct selection of a type of object, for example selection of a type of event, of a type of action, of a type of parameter, of a parameter calculation function, or of a graphical component from among those defined for the software module, etc.

When selecting an action in a list of actions, the actions are preferably grouped by category. A category contains for example all actions of a given type or all actions concerning a same kind of object. Preferably the assistant displays several buttons, each associated with a category of action and usable for causing the display of the list of actions within this category. For example, a button entitled “modify a graphical component” is displayed: a click on this button causes the display of all actions that enable to modify the state or appearance of a graphical component: actions like “mask a graphical component”, “display a graphical component”, “modify the position of a component”, “modify the color of a component”, etc. This organisation simplifies the search and selection of an appropriate action by the user, when a lot of actions are available.

During the selection of a parameter calculation function, only functions of the type required by the parameter to be defined for the action or event are presented to the user in a list, so as to prevent a function being chosen that is incompatible with the parameter to be defined.

In one embodiment, the displayed function list contains not only functions generating a value of the required type, but also functions generating a value that may be converted in such a type. In this embodiment, a button (or another graphical element of the user interface) is used to display the complete list (or to mask the complete list). For example, when the required parameter is of “text” type, only the functions generating a text will first be displayed. Then, when the user clicks on the button, the complete list will be displayed: this complete list includes functions generating a date, a numeral, a URL, an email address, etc. Those values will be converted automatically into text during execution of the software module. The advantage is to simplify the access to most commonly used functions, while preserving the possibility to access to an exhaustive function list.

For the definition of a parameter which is a graphical component identifier, selection from the drawing area Z3 of the graphical component to be taken into account can be proposed to the user, in addition to selection from a list of graphical components.

The wording of each of the elements of a list displayed in the control area Z2 may differ from that which appears in the graphical instruction of the object's description which will be displayed, after selection, in the description area Z1. This makes it possible to use more explicit wordings than those of the graphical instructions, which may sometimes be limited on account of aesthetic or practical considerations (in particular the problem of the size of the graphical instruction).

The control area Z2 is also used to display help messages, so as in particular to explain to the user what is expected of him at each step of the description of the software module. The control area Z2 is also used to display error or warning messages.

The assistant proposes description operations determined as a function of the current selection of the description area Z1, whether this selection is the result of a manual selection, requested by the user (in general, by a single or double mouse click), or of an automatic selection, performed authoritatively by the assistant. In a known manner, the expression current selection is understood to mean the currently selected graphical element of the user interface (this element being displayed in general with a different appearance from that used when this element is not selected), that is to say that one whose associated action will be executed if the user validates this selection (in general, by pressing the “enter” key of his keyboard) or that one into which the characters typed by the user on the keyboard of his computer will be entered.

The user is informed of the operations proposed by the assistant by means of the control area Z2, by this area displaying the interface element or elements associated with a restricted set of commands for modifying the description displayed in the area Z1. In particular, the interface elements BE, BA, L1, L2, L3, actually displayed and enabled are solely those necessary and sufficient for the implementation of a predefined description operation, the others not being displayed or not being enabled.

In addition to the commands triggered from the control area Z2, the user has the possibility of entering, in entry areas S1, S2, S3 of the description area Z1, one or more parameter calculation functions or a parameter value, generally in the form of a string of alphanumeric characters. The entry of a parameter value is performed by means of an appropriate editor, associated with the entry field, the nature of which depends on the type of parameter to be entered (e.g.: a calendar for entering a date). This makes it possible to avoid a format error during entry or formatting of the value entered.

After each entry (area Z1) or choice (area Z2) performed by the user, the assistant automatically modifies the current selection of the description area Z1 and therefore the choices proposed to the user in the control area Z2. The user is thus guided step by step in the design of his program.

The user also has the possibility of selecting an interface element of the drawing area Z3, for example a button B1: in this case drawing tools are displayed in the control area Z2 to allow the user to modify the appearance and/or the location of the interface elements.

Furthermore, the user has the possibility of manually selecting either the description area Z1 itself, or an area E1 or A1 for describing an event or an action, or a parameter entry area S1, S2, S3. Here again, the control choices proposed by the assistant to the user through the control area Z2 are limited as a function of the context, that is to say either of the state of the description area, or of the current selection resulting from this manual selection.

The table below lists the choice or choices proposed to the user.

| Context | Choice(s) proposed by the assistant |
|---|---|
| The description area Z1 is empty or selected | Addition of an event |
| An area E1 for describing an event is selected | Addition of an event |
| | Addition of an action associated with the event |
| | considered |
| An area A1 for describing an action is selected | Addition of an action that has to be executed |
| | before that which is selected |
| | Addition of an action that has to be executed |
| | after that which is selected |
| An entry area S1 for a parameter of type | Selection of a graphical component in the |
| ‘identifier of a graphical component’ is selected | drawing area Z3 and/or selection of a |
| | graphical component from a list of |
| | components |
| An entry area S1 for a parameter of another | Definition of said parameter: by entry of a |
| type is selected | value or by selection of a function in a list of |
| | functions compatible with the type of the |
| | parameter |

More precisely, the assistant is designed to automatically propose to the user a succession of elementary operations for describing the software module, the operation proposed at a given instant being dependent on the last operation performed by the user: this last operation is either a selection (of a description area E1, A1 or of an entry area S1, S2, S3) performed manually by the user, or a description operation, that is to say on the entries and/or choices performed by the user in the course of the last description operation. The assistant therefore operates according to a process which is iterative: a choice or entry determining the following description operation, which itself determines the choices and/or entries that are possible during the current description operation. The succession of description operations is therefore controlled and fixed by the assistant, only manual selections may change the succession order.

The assistant displays at a given instant a limited number of choices that are possible, as compared with those which would be available if the user were free to describe the events, actions and parameters in the order that he wanted, so as to prompt the user to undertake the description of the software module according to a predefined succession of description operations.

The choices proposed and/or selections performed automatically by the assistant subsequent to a description operation are the following.

After addition of a new object (event or action) and selection of a type of object from an object type list, the assistant determines whether this object requires a parameter. If it does, the assistant automatically selects the entry area S1 for the first parameter and proposes a list of parameter calculation functions that are compatible with this first parameter. If this object does not require a parameter, the assistant automatically selects the description area (E1, A1) for the object considered.

After definition of a parameter of an object (event or action), the assistant determines whether this object requires another parameter. If it does, the assistant automatically selects the entry area S1 for this other parameter and proposes a list of parameter calculation functions that are compatible with this other parameter. If this object does not require another parameter, the assistant automatically selects the description area (E1, A1) for the object considered.

When the assistant has automatically selected an entry area for a parameter of an object (event or action), the user has the possibility of selecting an entry area for another parameter of this same object so as to define this other parameter. The user can furthermore, if he so wishes, select a graphical element displayed in the description area Z2 with a view to modifying/updating a part of the description comprising this graphical element. The definition operations proposed to the user are in this case dependent on the graphical element selected and are those defined in the table below.

When the assistant has automatically selected a description area for describing an object (event or action), the user has the possibility of adding an object, (adding an event and/or adding an action) according to what is described in the table above in the case of manual selection of an object description area.

By virtue of the invention, problems of syntax in the description of an action or of an event are fully handled by the assistant, by display in the description area Z1 of a graphical description of the action or of the event which limits the work of the user to selection work and/or parameter entry work.

This mode of programming makes it possible to implement a function for validating the description so as in particular to signal errors or omissions, if any, to the user, such as:
the absence of any event,
the absence of any action associated with an event,
the absence of a parameter.

In the case of the absence of a parameter, the expected type and the way to supplement the parameter are indicated to the user so as to guide him here again.

The principle of the invention prevents the user from choosing or entering a parameter of an incorrect type, there cannot therefore be any type-related error.

Moreover, the assistant, having knowledge of a predefined succession of required description operations, is able to signal to the user that a proposed description operation has not been performed by the user. This can occur if the user decides for example to modify a graphical element of the description displayed in the description area Z2 and selects this graphical element. In this case, the assistant stores in a memory the description operation proposed at the moment of this selection and will again propose to the user that he perform this description operation when the modification of the graphical element considered is executed.

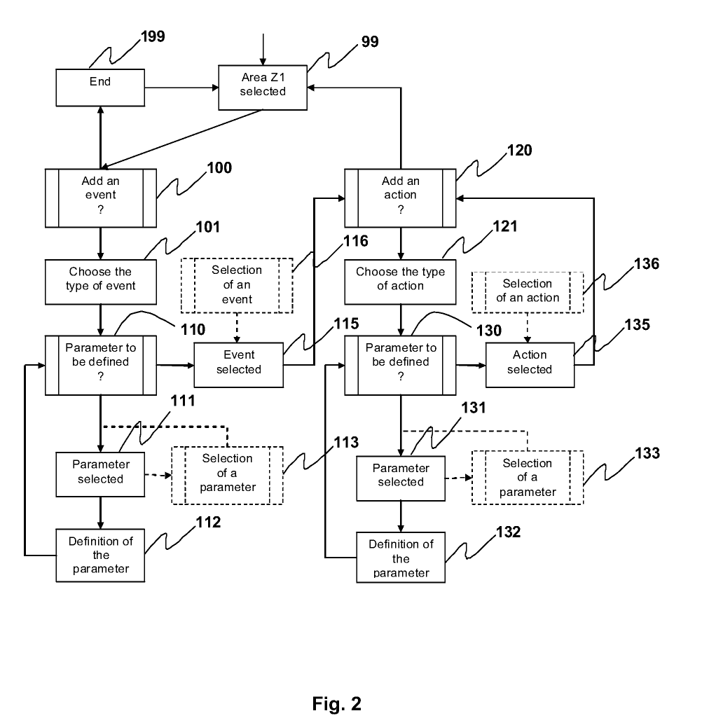

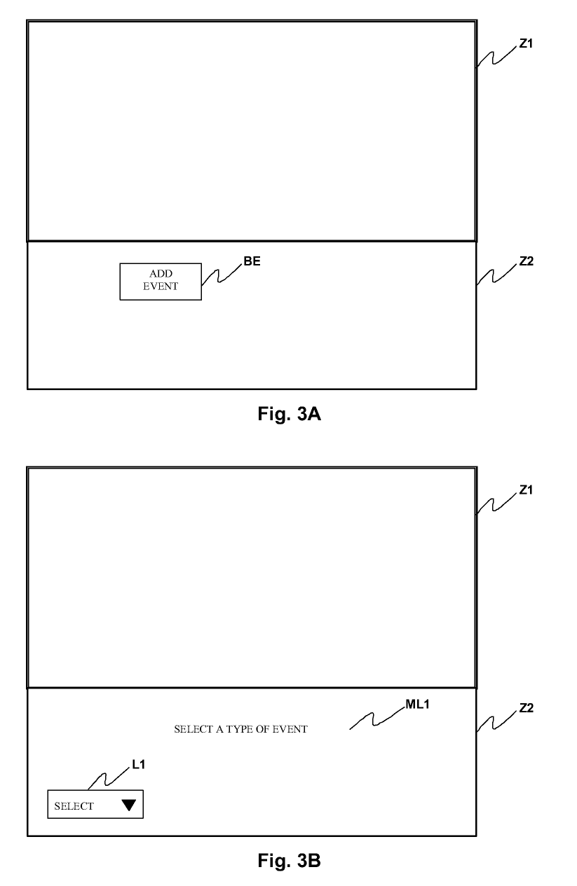

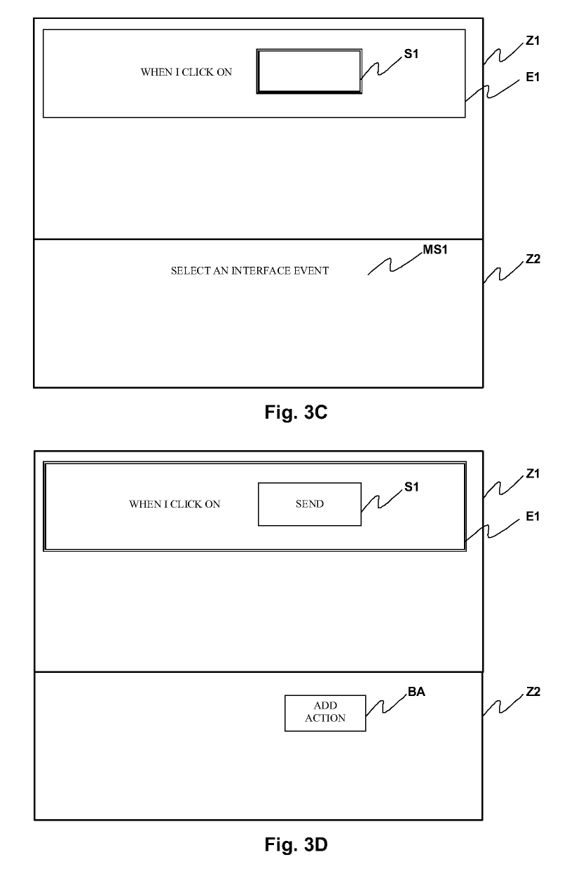

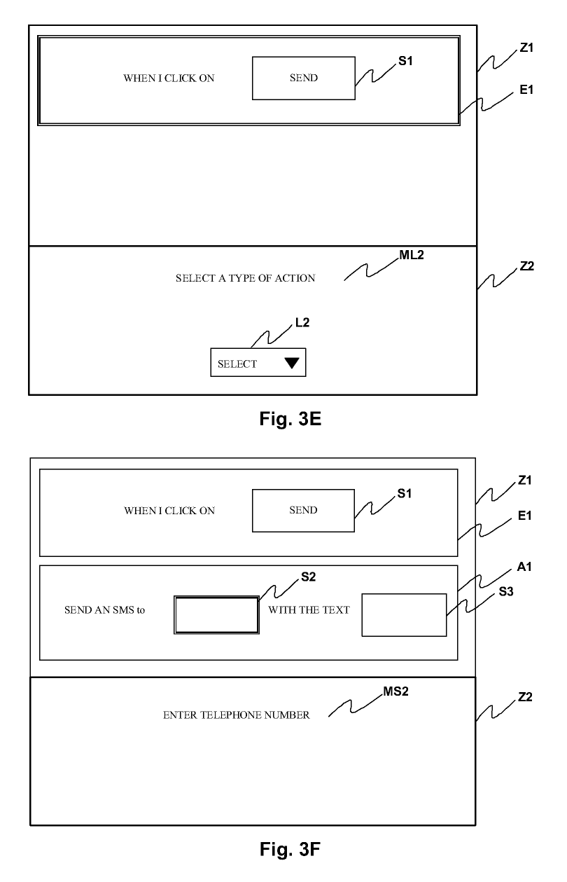

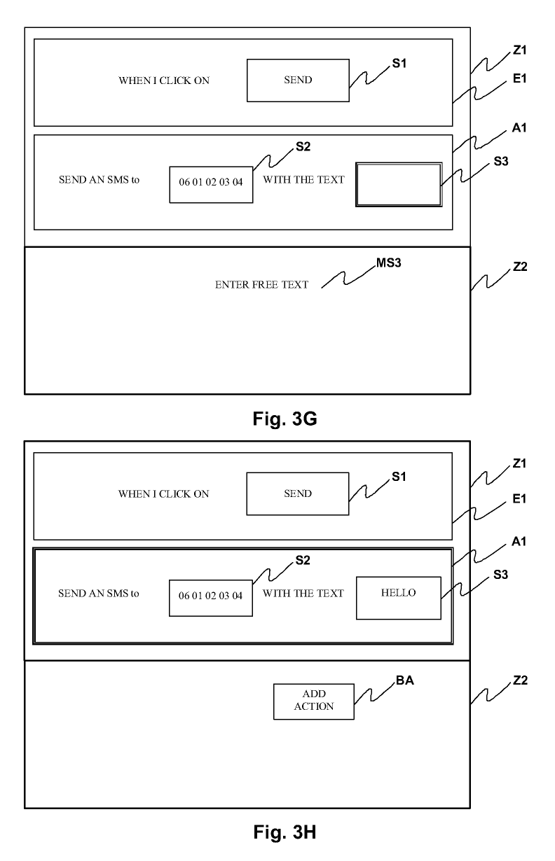

An exemplary succession of description operations is described by reference to FIG. 2 (steps of the method according to the invention that are implemented by the assistant) and in FIGS. 3A to 3H, representing what happens in evolution of the areas Z1 and Z2 in the course of the execution of these steps.

The method according to the invention starts at step 99, in the course of which the assistant automatically selects the description area Z1. The areas Z1 and Z2 have the appearance represented in FIG. 3A: the description area Z1 is selected (depicted in relief with a thicker outline) and the control area Z2 comprises an interface element BE for adding an event. The description operation imposed on the user is therefore a description operation for adding an event, and then for describing an event, in accordance with steps 101 to 115. This description operation itself comprises elementary description operations:
an elementary operation (see step 101) for selecting a type of event from among those proposed, the user being unable, at this juncture, to perform any other description operation except for selecting a graphical element of the description area Z2, and then,
an elementary operation (see steps 111 to 115) for defining the parameter or parameters, if any, of the event for which a type was selected in step 101, the user being unable, at this juncture, to perform any other description operation except for selecting a graphical element of the description area Z2.

In step 100, the assistant detects whether the user clicks on the interface element BE. If so, step 101 is executed, otherwise it is the final step 199 which is executed. It is assumed here that the user clicks on the interface element BE.

In step 101, the areas Z1 and Z2 have the appearance represented in FIG. 3B: the description area Z1 is still selected and the control area Z2 comprises the interface element L1 for selecting a type of event, accompanied by a message ML1 to invite the user to select a type of event. During this step 101, the user must therefore choose a type of event and cannot perform any other description operation. It is assumed here that during step 101 the user chooses an event of the type “when I click on an interface component”.

In step 110, the assistant determines whether any parameter needs defining for the event undergoing definition (the one whose type was selected in step 101). If so, step 111 is executed, otherwise step 115 is executed.

In step 111, the areas Z1 and Z2 have the appearance represented in FIG. 3C: a description area E1 corresponding to the event chosen in step 101 is displayed in the area Z1, an entry area S1 associated with the first parameter of this event being selected (depicted in relief with a thicker outline). Since this first parameter is intended to receive a graphical component identifier, the control area Z2 comprises a message MS1 to invite the user to select a graphical component in the drawing area Z3, having the appearance represented in FIG. 1.

In step 112, the user defines the first selected parameter, by selecting the button B1.

The assistant executes step 110 again, and since no other parameter has to be defined for the event undergoing definition, it is step 115 which is executed subsequent to this step 110.

In step 115, the assistant selects the event which has just been defined. The areas Z1 and Z2 then have the appearance represented in FIG. 3D: the description area E1 corresponding to the event considered is depicted in relief (displayed with a thicker outline), the control area Z2 comprising an action addition interface element BA. The description operation imposed on the user at this juncture is therefore an operation for adding an action, followed by an operation for describing an action, corresponding to steps 120 to 135. This description operation itself comprises two elementary operations:
an elementary operation (see step 121) for selecting a type of action from among the types proposed, the user being unable, at this juncture, to perform any other description operation except for selecting a graphical element of the description area Z2, and then,
an elementary operation (see steps 131 to 135) for defining the parameter or parameters, if any, of the action for which a type was selected in step 121, the user being unable, at this juncture, to perform any other description operation except for selecting a graphical element of the description area Z2.

In step 120, the assistant detects whether the user clicks on the interface element BA. If so, step 121 is executed, otherwise it is the initial step 99 which is executed. It is assumed here that the user clicks on the interface element BA.

In step 121, the areas Z1 and Z2 have the appearance represented in FIG. 3E: the description area E1 corresponding to the previously defined event is selected and the control area Z2 comprises the interface element L2 for selecting a type of action, accompanied by a message ML2 to invite the user to select a type of action. During this step 121, the user must therefore choose a type of action and cannot perform any other description operation. It is assumed here that during step 121 the user chooses an action of the type “send an SMS message”.

In step 130, the assistant determines whether any other parameter needs defining for the action undergoing definition (the one whose type was selected in step 121). If so, step 131 is executed, otherwise step 135 is executed.

In step 131, the areas Z1 and Z2 have the appearance represented in FIG. 3F: a description area A1 corresponding to the action chosen in step 121 is displayed in the area Z1, an entry area S2 associated with the first parameter of this action being selected (depicted in relief with a thicker outline). Since this first parameter is intended to receive a telephone number, the control area Z2 comprises a message MS2 to invite the user to enter a number into the entry area S2.

In step 132, the user defines the first selected parameter, by entering a number into the entry area S2.

The assistant executes step 130 again, and since a second parameter has to be defined for the action undergoing definition, it is step 131 which is executed subsequent to this step 130.

In step 131, the areas Z1 and Z2 have the appearance represented in FIG. 3G: an entry area S3 associated with the second parameter of the action undergoing definition being selected (depicted in relief with a thicker outline). Since this second parameter is intended to receive a text, composed freely by the user, the control area Z2 comprises a message MS3 to invite the user to enter a text into the entry area S3.

In step 132, the user defines the second selected parameter, by entering a text into the entry area S3.

Then the assistant executes step 130 again, and since no other parameter has to be defined for the action undergoing definition, it is step 135 which is executed subsequent to this step 130.

In step 135, the assistant selects the action which has just been defined. The areas Z1 and Z2 then have the appearance represented in FIG. 3H: the description area E1 corresponding to the action defined is depicted in relief (displayed with a thicker outline), the control area Z2 comprising an action addition interface element BA. The following description operation proposed to the user is therefore an operation for describing an action, corresponding to steps 120 to 135. Step 120 is executed again, subsequent to step 135.

In addition to the predefined succession of definition operations which has just been described, the assistant offers the user various ways of modifying or supplementing the existing description:
modification of a parameter of an event (respectively an action): in this case, the user selects in step 113 (respectively 133), the entry area for the parameter to be modified; this selection can be performed at any moment, in particular while defining an event (respectively an action), in such a way for example as to allow the user to define the parameters of an object in the order that he so wishes; step 111 (respectively 131) is then executed subsequent to step 113 (respectively 133);
addition of an action: in this case, the user selects in step 116 (respectively 136) the area for describing the event to which an associated action is to be added (respectively the area for describing the action subsequent to which an action is to be added); step 115 (respectively 135) is then executed subsequent to step 116 (respectively 136), the assistant performing the selection of the description area considered and displaying in the control area Z2 an action addition interface element BA; the description operation imposed on the user at this juncture is therefore an operation for describing an action, corresponding to the following steps 120 to 135; optionally, an interface element—not represented—for deleting the action considered is displayed simultaneously with the interface element BA;
addition of an event: in this case, the user selects the description area Z1 and the assistant executes step 99: the description area Z1 is selected (depicted in relief with a thicker outline) and the control area Z2 comprises an interface element BE for adding an event; the description operation imposed at this juncture on the user is therefore an operation for describing an event, corresponding to the following steps 100 to 115; optionally, an interface element—not represented—for deleting the event considered is displayed simultaneously with the interface element BE.

This invention has been described within the framework of a tool for programming widgets. However, it is applicable to the programming, by means of a graphical language, of any software. An application of the principle of the invention to text-language programming is also conceivable.

What is claimed is:

1. A method for aiding the programming of software, the method comprising the steps:
a step of displaying a description area used to display a graphical description of at least one action to be executed by said software subsequent to an occurrence of at least one event,
at least one step of displaying in a control area at least one interface element by mean of which a user may undertake an operation for describing said action or event causing an update of said graphical description,
the description operation currently proposed being dependent each time on the last description operation performed, in such a way as to prompt the user to define said software according to a predefined succession of description operations.

2. The method according to claim 1, in which, if it is detected that the user has selected of a graphical element in the description area, the description operation proposed is dependent on the graphical element selected.

3. The method according to claim 1, in which said description area comprises a selectable action description area for the description of said action, wherein the proposed description operation is an addition of another action to be executed before of after said action when said action description area is selected.

4. The method according to claim 1, in which said description area comprises a selectable event description area for the description of said event, wherein the proposed description operation is an addition of another event or of another action associated with said event when said event description area is selected.

5. The method according to claim 1, in which the description operation currently proposed is a description operation that has already been proposed to the user but has not been performed by the user.

6. The method according to claim 1, comprising a step of executing a function for validating the description so as to signal to the user an omission, such as:
the absence of any event,
the absence of any action associated with an event,
the absence of a parameter required for the definition of one action or event.

7. The method according to claim 1, in which said software is able to be described on the basis of objects representing an action or an event, and the currently proposed description operation is one of the operations included in the group comprising:
addition of an object,
choice of a type of object for an object to be created,
definition of a parameter for a created object.

8. The method according to claim 1, in which, when the currently proposed description operation includes choosing a type of object, a list of user interface elements each associated with a type of object is displayed during the display step.

9. A recording medium readable by a data processor on which is recorded a program comprising program code instructions for the execution of the steps of a method according to claim 1.

10. A device for aiding the programming of software, said device comprising an assistant for
displaying a description area used to display a graphical description of at least one action to be executed by said software subsequent to an occurrence of at least one event,
displaying in a control area at least one interface element by mean of which a user may undertake an operation for describing said action or event causing an update of said graphical description,
the description operation currently proposed being each time dependent on the last description operation performed, in such a way as to prompt the user to define said software according to a predefined succession of description operations.
